(19) United States
(12) Patent Application Publication
(10) Pub. No.: US 2012/0064211 A1
(43) Pub. Date: Mar. 15, 2012

(54) MULTIPURPOSE CHEF BASKET

(75) Inventors: MICHAEL SANDER, DENVILLE, NJ (US); ISSIE KROLL, CHATHAM, NJ (US)

(73) Assignee: TV WINNERS, INC., MADISON, NJ (US)

(21) Appl. No.: 13/227,107

(22) Filed: Sep. 7, 2011

Related U.S. Application Data
(60) Provisional application No. 61/381,797, filed on Sep. 10, 2010.

(51) Int. Cl. A47J 37/12; B08B 3/06; A23L 1/015; A23L 1/01

(52) U.S. Cl. 426/438; 99/410; 426/665; 426/509; 134/25.3; 426/478

(57) ABSTRACT

A chef basket is disclosed. The basket includes a ring, a plurality of overhangs, the overhangs coupled to the ring and juxtaposed over each neighboring overhang, a plurality of interlocking wires forming a straining surface, the straining surface coupled to the ring; and at least two handles, the at least two handles rotatably coupled to the ring, wherein at least five different reversible configurations or orientations, including a collapsed configuration, a first standing configuration, a second standing configuration, a first configuration, and a second configuration, are formed.

### CROSS-REFERENCE TO RELATED APPLICATION

This application claims the benefit of U.S. Provisional Patent Application Ser. No. 61/381,797, filed Sep. 10, 2010, which is herein incorporated by reference in its entirety.

### BACKGROUND

1. Technical Field

Embodiments of the present disclosure generally relate to a food preparation technology and, more particularly, to a multipurpose chef basket comprising a collapsible and reversible wire mesh straining surface.

2. Description of the Related Art

It is well known that all animals depend on food for sustenance. People have been preparing edible food since the dawn of mankind. By applying a heat source, the food is cooked until consumable by a human digestive system. For example, people apply fire or steam in order to cook meat and/or vegetables thoroughly. As another example, people heat water to a boil in order to cook certain foods, such as eggs or pasta, which are immersed therein. In yet another example, people remove bacteria, particulate soil, and other undesirable or inedible components from raw or cooked vegetables before serving. A common denominator amongst the various methods of preparing food is the desire to handle the food while in contact with water. This often involves straining or separating the water (e.g., hot/boiling water) from the food.

Typically, a chef needs multiple utensils to perform washing, straining, boiling and steaming of food, e.g., vegetables. Specifically, a colander for washing, a strainer for straining and boiling, and a steamer basket for steaming. Having three utensils requires excessive storage space in a modern kitchen.

Therefore, there is a need in the art for a multipurpose chef basket comprising a collapsible and reversible wire mesh straining surface to facilitate washing, straining, boiling, frying, deep-frying, and steaming.

### SUMMARY

Various embodiments of the present disclosure generally include a method and apparatus for preparing food using a reversible and collapsible wire mesh straining surface. A basket is disclosed, which includes a ring, a plurality of overhangs, the overhangs coupled to the ring and juxtaposed over each neighboring overhang, a plurality of interlocking wires forming a straining surface, the straining surface coupled to the ring; and at least two handles, the at least two handles rotatably coupled to the ring, wherein at least five different reversible configurations or orientations, including a collapsed configuration, a first standing configuration, a second standing configuration, a first configuration, and a second configuration, are formed. In the first configuration, food placed in the chef basket may be immersed in a liquid, while in the second configuration the basket supports food above a liquid.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a wire mesh straining surface in a collapsed position according to various embodiments;

FIG. 2 illustrates a wire mesh straining surface in a standing position according to various embodiments;

FIG. 3 illustrates a wire mesh straining surface in a first configuration that may be used to boil, steam, fry, deep-fry, or wash food according to various embodiments;

FIG. 4 illustrates a wire mesh straining surface in second configuration that may be used to steam food according to various embodiments;

FIG. 5 illustrates a top view of the chef basket in a collapsed position;

FIG. 6 illustrates a perspective view of the chef basket in a standing position;

FIG. 7 illustrates a perspective view of the chef basket in a first orientation; and

FIG. 8 illustrates a perspective view of the chef basket in a second orientation.

To facilitate understanding, identical reference numerals have been used, where possible, to designate comparable elements that are common to the figures. The figures are not drawn to scale and may be simplified for clarity. It is contemplated that elements and features of one embodiment may be beneficially incorporated in other embodiments without further recitation.

### DETAILED DESCRIPTION

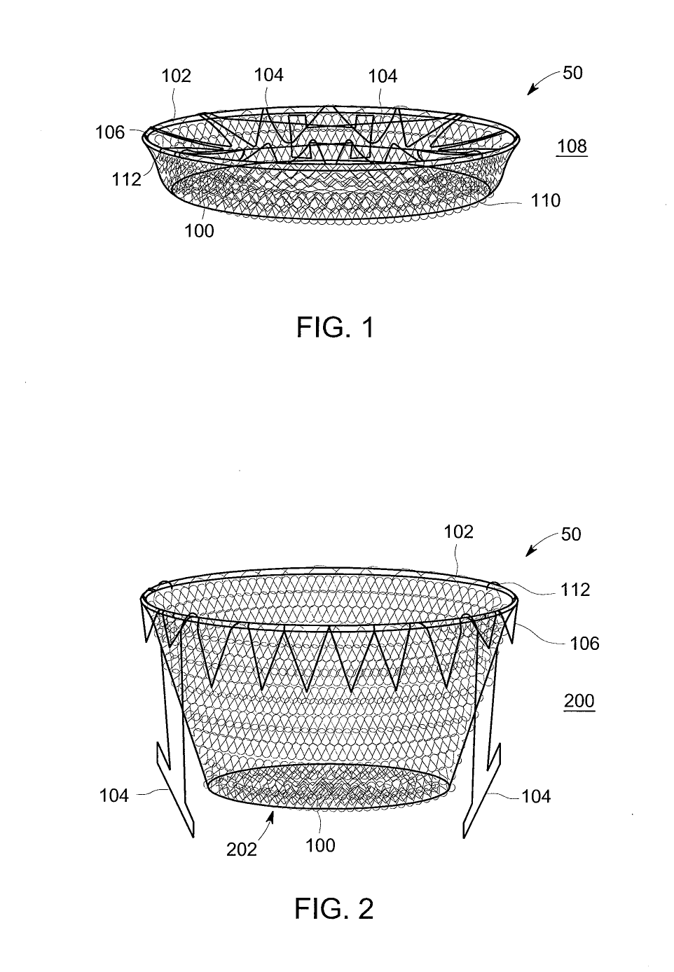

FIG. 1 illustrates chef basket 50 comprising a wire mesh straining surface 100 in a collapsed position 108 according to various embodiments. Specifically, FIG. 1 illustrates a top view of the wire mesh straining surface 100, which is coupled to a ring 102. The wire mesh straining surface 100, generally, includes several interlocking wires 110 that form a framework for enabling food to be immersed in and then, separated from a liquid, such as boiling water or hot cooking oil. One or more outer most wires wrap around the ring 102 in order to maintain a desired shape for the wire mesh straining surface 100 (hereinafter referred to as the straining surface 100).

Furthermore, two or more handles 104 are attached to the ring 102 and positioned above the straining surface 100. A user lifts the basket 50 using these handles 104. The user may also rotate the handles 104 about the ring 102. By flipping or reversing the straining surface 100, the user can use two different configurations or orientations for the purpose of preparing food.

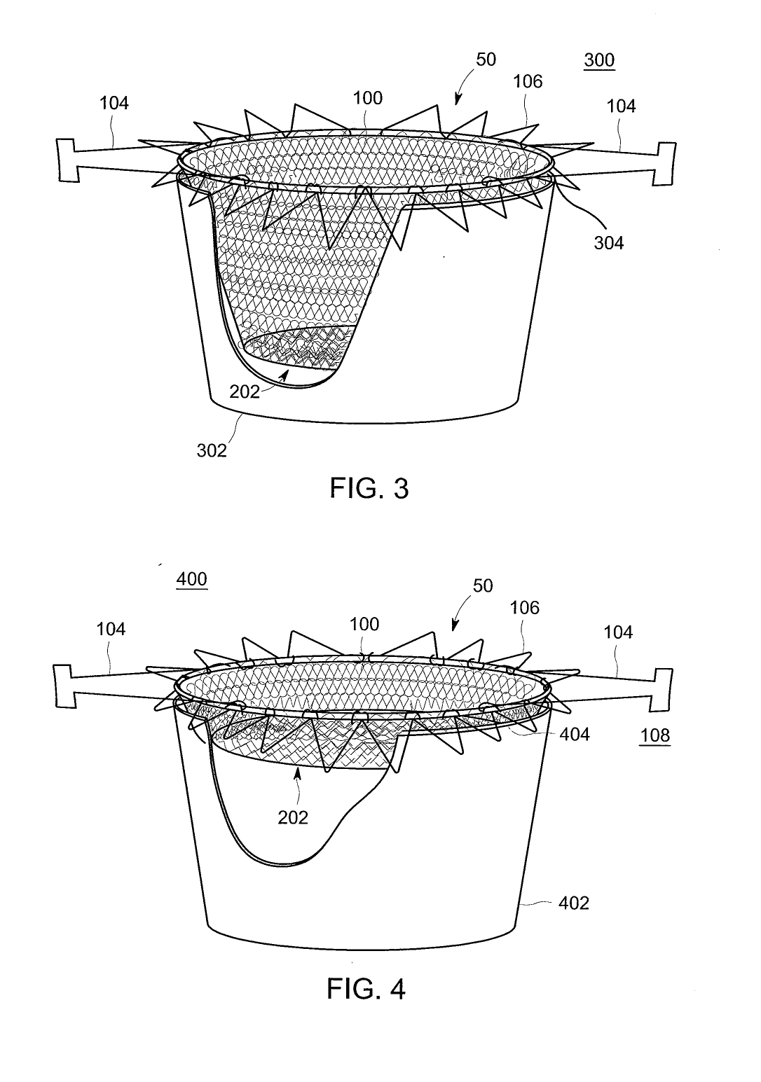

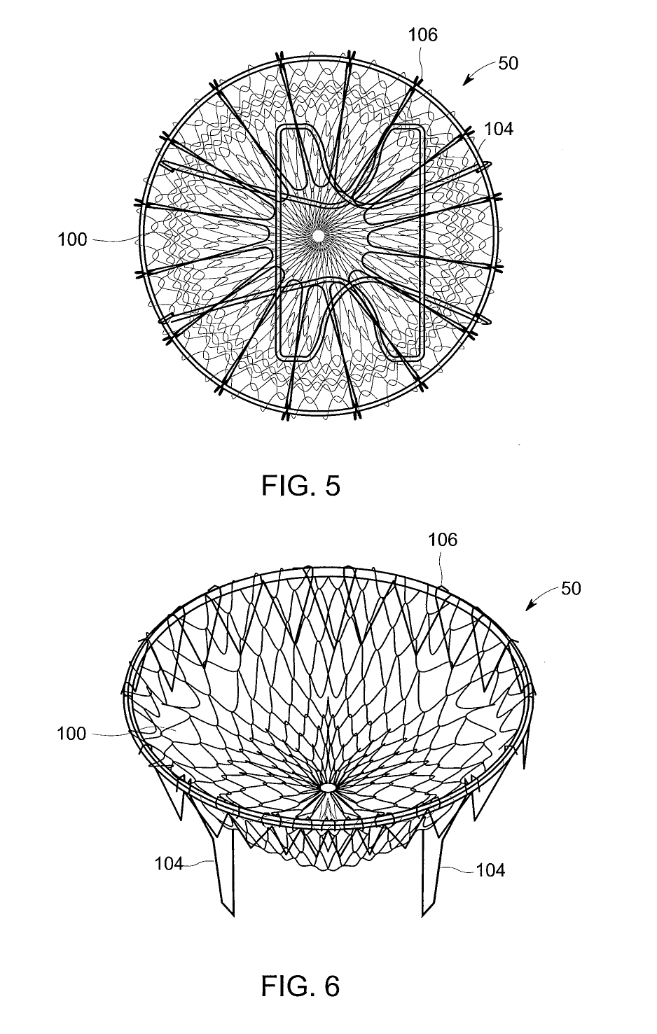

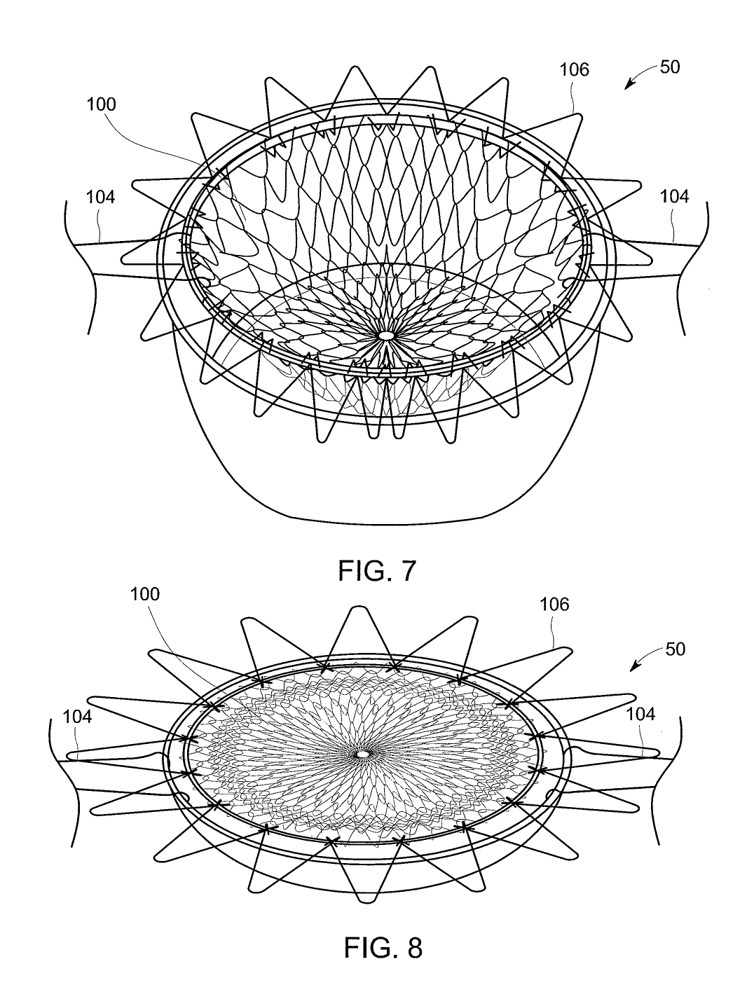

In addition to the handles 104, a plurality of overhangs 106 are attached to the ring 102. In some embodiments, the plurality of overhangs 106 maintain a position for the straining surface 100 within cookware. For example, when in an uncollapsed configuration (see FIGS. 3 and 4) the plurality of overhangs 106 may protrude over an edge of a cooking pot/pan and provide support for the straining structure 100 while immersed in a liquid therein. Each overhang 106 couples with the ring 102 via a pair of complimentary curved ends 112. Each curved end 112 of a particular overhang 106 is juxtaposed with a curved end of another overhang 106. In other words, the each curved end is positioned on the ring 102 next to the curved end of the other overhang 106 such that these curved ends push up against each other when the plurality of overhangs 106 are protruding off the ring 102. Accordingly, the plurality of overhangs 106 are held together and form a rigid, continuous support structure.

FIG. 2 illustrates the chef basket 50 in a standing position 200 according to various embodiments. Because the handles 104 are rotatable about the ring 102, the user may move and position the handles 104 below the straining surface 100. As a result, the plurality of overhangs 106 open up to expose the straining surface 100 to food and/or liquid. When positioned upright with respect to a surface, such as a sink, the handles 104 permit the straining surface 100 to fully extend and stand independently. The woven wires 110 form a basket 202 that is sized to fit food (e.g., vegetables, fruit, cooked pasta, and the like).

For example, the straining surface 100 may form a portion of a colander (i.e., a strainer). A user may desire to wash vegetables or strain cooked food (i.e., pasta) before serving. The user may perform such food preparation activities in a sink. While in the standing position 200, the straining surface 100 is not in contact with the surface of the sink (i.e., the handles 104 are longer than the depth of the basket 202). Therefore, the user may rinse the vegetables with water without actually holding the colander his/herself or having the straining surface contact the surface of the sink. The water separates from the vegetables via the straining surface 100.

The user, alternatively, may use the colander to strain cooked pasta from boiling water. Similar to rinsing vegetables, the user does not need to hold the colander while pouring the boiling water and cooked pasta onto the straining surface 100. While the boiling water separates from the cooked pasta via the straining surface 100, the cooked pasta does not contact the surface of the sink preventing contamination from bacteria and/or other pathogens.

FIG. 3 illustrates the wire mesh straining surface 100 in a first configuration 300 that may be used to, for example, boil, fry and strain food in combination with cookware 302 according to various embodiments. In some embodiments, the reversible position 300 is formed by orientating each and every wire of the straining surface 100 inwards towards a center. Such an orientation enables a maximum amount of aperture space to be formed by interlocking wires as well as a maximum elongation of the straining surface 100. The first configuration 300 facilitates the basket 202 being immersed in any liquid in the pot 302. In order to form the first configuration 300, the handles 104 are moved from a position above the straining surface 100 and placed alongside the ring 102 and exterior to the straining surface 100 (e.g., the handles 104 are horizontal). As the plurality of overhangs 106 also move to a position alongside the ring 102 and horizontal, the woven wires of the straining surface 100 become interlocked because of gravitational forces.

For example, the cookware 302 (shown in a cut away view to expose the basket 202) may include a cooking pot for boiling food, such as pasta, soup and/or the like. When the straining surface 100 is in the first configuration 300, a user may use the handles 104 to lift and place the basket 202 into the cooking pot immersing any food in the boiling water. The plurality of overhangs 106 interlock one another and rest on an outer edge 304 of the cooking pot 302. By providing support for the basket 202, the plurality of overhangs 106 prevent the handles 104 from falling in the boiling water. If the straining surface 100 and the handles 104 are completely immersed in the boiling water, the user cannot remove the prepared food without first removing the boiling water. Subsequently, the user may use the handles 104 to lift the straining surface 100 out of the cooking pot without touching the prepared food, the boiling water or the surface of the cooking pot.

FIG. 4 illustrates the chef basket 50 having the wire mesh straining surface 100 in a second configuration 400 that is being used with cookware 402 according to various embodiments. In some embodiments, the second configuration 400 is formed by orientating each and every wire of the straining surface 100 outwards towards an exterior. Such an orientation closes apertures formed by interlocking wires and the straining surface 100 only partially extends such that the basket 202 does not become immersed in liquid within the cookware 402. When compared with a configuration where the wires are oriented inwards (e.g., the first configuration 300 of FIG. 3), the second configuration 400 shortens an amount of aperture space as well as a length of elongation of the straining surface 100. In other words, the interlocking wires do not extend as far and create the straining surface 100 with less surface area.

In order to form the second configuration 400, the handles 104 rotate about the ring 102 from a position above the straining surface 100 and placed exterior to the straining surface 100 and are horizontally oriented. If the wires are oriented inwards, the straining surface 100 is reversed. Otherwise, the wires of the straining surface 100 have a correct orientation. As the plurality of overhangs 106 also move to a position alongside the ring 102 and are horizontally oriented, the wires of the straining surface 100 become interlocked because of gravitational forces.

For example, the cookware 402 may include a cooking pot for steaming food, such as vegetables and/or the like. When the straining surface 100 is in the second configuration 400, a user may use the handles 104 to lift and place the basket 202 in the cooking pot such that the food comes into close contact with the heated liquid, such as hot or boiling water. The plurality of overhangs 106 rest on an outer edge 404 of the cooking pot. By providing support for the basket 202 in the second orientation 400, the plurality of overhangs 106 prevent the handles 104 and/or the straining surface 100 from falling into the heated liquid. If the basket 202 and/or the handles 104 are immersed in the heated liquid, the user cannot remove the prepared food without removing the heated liquid. Subsequently, the user may use the handles 104 to lift the basket 202 out of the cooking pot without touching the prepared food, the heated liquid and/or the cooking pot.

Although some embodiments have been discussed above, other implementations and applications are also within the scope of the following claims. Although the invention herein has been described with reference to particular embodiments, it is to be understood that these embodiments are merely illustrative of the principles and applications of the present invention. It is therefore to be understood that numerous modifications and variations may be made to the illustrative embodiments and that other arrangements may be devised without departing from the spirit and scope of the present invention as defined by the following claims.

What is claimed is:

1. A basket, comprising:
a ring;
a plurality of overhangs, the overhangs coupled to the ring and juxtaposed over each neighboring overhang;
a plurality of interlocking wires forming a straining surface, the straining surface coupled to the ring; and
at least two handles, the at least two handles rotatably coupled to the ring;
wherein at least five different reversible configurations, including a collapsed configuration, a first standing configuration, a second standing configuration, a first configuration, and a second configuration, are formed.

2. The basket of claim 1, wherein the plurality of overhangs comprise curved ends, each curved end juxtaposed with a curved end of an adjacent overhang.

3. The basket of claim 1, wherein the collapsed configuration comprises a low profile, facilitating easy storage.

4. The basket of claim 1, wherein the handles are below the straining surface and the straining surface elongates to a deep, maximum surface area, and the basket stands independently in the first standing configuration for preparing food.

5. The basket of claim 1, wherein the handles are below the straining surface and the straining surface elongates to a shallow, minimum surface area, and the basket stands independently in the second standing configuration for preparing food.

6. The basket of claim 1, wherein the handles are parallel to a horizontal cooking surface, the straining surface elongates to a deep, maximum surface area, and the basket is formed into the first configuration for preparing food.

7. The basket of claim 1, wherein the handles are parallel to a horizontal cooking surface, the straining surface elongates to a shallow, minimum surface area, and the basket is formed into the second configuration for preparing food.

8. A method of preparing food, the method comprising:
placing the handles of a basket below a straining surface;
forming a first configuration having a deep volumetric space;
placing food within the volumetric space; and
performing an operation to the food.

9. The method of claim 8, further comprising inverting the orientation of the basket and rotating the handles to a second configuration to form a shallow volumetric space.

10. The method of claim 8 or 9, wherein the performing step includes boiling, steaming, frying, deep-frying, washing, or straining food.
